(19) United States
(12) Patent Application Publication
(10) Pub. No.: US 2011/0251724 A1
(43) Pub. Date: Oct. 13, 2011

(54) SERVER AND METHOD FOR DETECTING WORK STATUSES OF AIR COMPRESSORS

(75) Inventors: CHI-CHIH WANG, Tu-Cheng (TW); BING-YU HE, Shenzhen City (CN); ZHONG-GEN ZHAN, Shenzhen City (CN); PAN FU, Shenzhen City (CN); LI-BO CHEN, Shenzhen City (CN)

(73) Assignees: HON HAI PRECISION INDUSTRY CO., LTD., Tu-Cheng (TW); GDS Software (ShenZhen) Co., Ltd, ShenZhen City (CN)

(21) Appl. No.: 13/015,591

(22) Filed: Jan. 28, 2011

(30) Foreign Application Priority Data
Apr. 8, 2010 (CN) 201010142770.1

(51) Int. Cl. G06F 15/00; G05D 23/00

(52) U.S. Cl. 700/276; 702/183

(57) ABSTRACT

A server and method detects work statuses of air compressors in a pipeline system. The server reads pipeline system data and air compressor data measured from the pipeline system and determines if work status of an air compressor needs to be changed. A warning message is generated by the server and sent to an alarm computer in response to a determination that the work status of the air compressor needs to be changed. The server saves the pipeline system data and the air compressor data into a database system.

### BACKGROUND

1. Technical Field

Embodiments of the present disclosure relate to detection technology, and particularly to a server and method for detecting work statuses of air compressors.

2. Description of Related Art

An air compressor is a device that converts electrical power or gas into kinetic energy by pressurizing and compressing air. An ideal air compressor would have no energy loss, and would be 100% efficient. In practice, the energy loss is consumed by the parts of the air compressor. The energy loss in the air compressors is a serious waste of resource. Reducing the energy loss in the air compressor can make the air compressor more efficient. Currently, air compressor detection methods for the energy loss depend on manual operation. However, the methods may be time-consuming or imprecise.

### BRIEF DESCRIPTION OF THE DRAWINGS

FIG. 1 is a systematic diagram of one embodiment of an air compressor detection system.

FIG. 2 is a block diagram of one embodiment of a server of the air compressor detection system in FIG. 1.

FIG. 3 is a flowchart of one embodiment of a method for detecting a work status of an air compressor.

### DETAILED DESCRIPTION

All of the processes described below may be embodied in, and fully automated via, function modules executed by one or more general purpose processors of a computer. Some or all of the methods may alternatively be embodied in specialized hardware. The function modules may be stored in any type of computer-readable medium or other computer storage device.

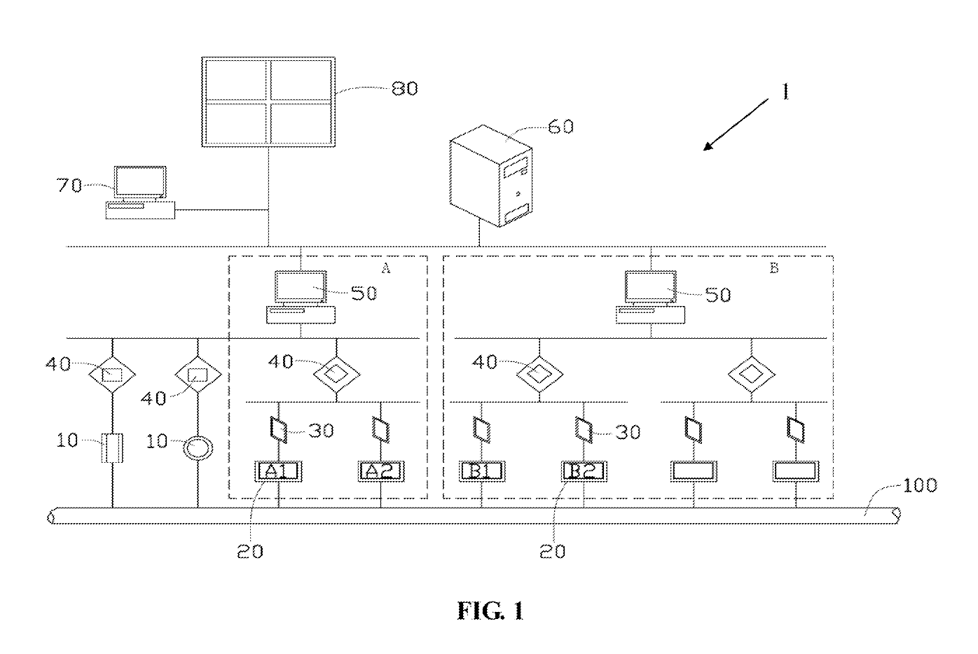

As used herein, the term, “pipeline system data” is defined as data generated by a pipeline system. The pipeline system is a pipe or pipe system that transports gas. The term, “sensor” is defined as a device for acquiring the pipeline system data from the pipeline system. The term, “air compressor data” is defined as data generated by an air compressor. The air compressor is a device that controls the air pressure of the pipeline system by compressing the air into the pipeline system and releasing the compressed air from the pipeline system. The term, “air compressor controller” is defined as a device for acquiring the air compressor data from the air compressor. The term, “the data converter” is defined as a device and or software that converts the pipeline system data and the air compressor data into a data format (e.g., a hexadecimal format). It may be understood that the term, “data” may refer to a single data item or may refer to a plurality of data items. These terms, with reference to the FIGS. 1-3, will be described in greater detail below.

FIG. 1 is a systematic diagram of one embodiment of an air compressor detection system 1. The air compressor detection system 1 may automatically change work statuses of the air compressors 20 in accordance with the data detected from the air compressors 20 and the pipeline system 100. The work statuses of the air compressors 20 include a power-on work status and a power-off work status.

The air compressor detection system 1 includes a pipeline system 100, one or more sensors 10, one or more air compressors 20 (e.g., A1, A2, B2, B3). One or more air compressor controllers 30, one or more data converters 40, and one or more servers 50 located in one or more areas, such as an area A and an area B. The pipeline system 100 passes through the one or more areas, as shown in FIG. 1, the area A and the area B. The following description takes the area A as example.

In some embodiments, each sensor 10 is connected to the pipeline system 100, as shown in FIG. 1. Each sensor 10 collects the pipeline system data of the pipeline system 100 (e.g., air temperatures, flow rates and air pressures) and sends the collected pipeline system data to the data converter 40. The sensors 10 may be, but are not limited to, an infrared sensor, a data acquiring sensor, a microwave sensor, a flow meter or a pressure sensor. In one embodiment, the sensors 10 may be installed at different positions of the pipeline system 100. Each of the sensors 10 may communicate with the data converter 40 using an electrical cable. Each of the sensors 10 may include a communication unit for communicating with the data converter 40. For example, the communication unit may be a radio transceiver.

The air compressor 20 is connected to the pipeline system 100 and controls the air pressure of the pipeline system 100. In one embodiment, the air compressor 20 compresses the air and injects the compressed air into the pipeline system 100 if the air pressure of the pipeline system is less than a predetermined air pressure (e.g., 25 mega pascals [MPa]), the air compressor 20 releases the compressed air from the pipeline system 100 if the air pressure of the pipeline system is greater than the predetermined air pressure (e.g., 25 MPa). The air compressor 20 may be, but are not limited to, a positive-displacement air compressor or a negative-displacement air compressor.

The air compressor controller 30 is connected to the air compressor 20, as shown in FIG. 1. The air compressor controller 30 collects the air compressor data from the air compressor 20 and sends the collected air compressor data to the data converter 40.

The data converter 40 is connected to the sensor 10 and the air compressor 20. The data converter 40 converts the collected pipeline system data and the collected air compressor data into a data format (e.g., a hexadecimal format) so that the server 50 can read the converted pipeline system data and the converted air compressor data via a network. In one embodiment, the network may be a wide area network (e.g., the Internet) or a local area network.

The server 50 is connected to the database system 60 using database connectivity interfaces, such as open database connectivity (ODBC) or java database connectivity (JDBC). In one embodiment, the server 50 may be a data processing device or a computing device such as a personal computer, an application server, or a workstation, for example.

The server 50 is further connected to an alarm computer 70. The server 50 may process the converted pipeline system data and the converted air compressor data, and determine if a work status of the air compressor 20 needs to be changed according to the processed data. In addition, the server 50 in other areas may be a backup server. For example, if the server 50 in area A does not work, the server 50 in area B will automatically act as the backup server. Further details of the server 50 will be described below.

The alarm computer 70 connects to a display device 80 (e.g., a video wall) for notifying a user that the work status of the air compressor 20 needs to be changed, such as, from the power-on work status to the power-off work status. It is understood that the video wall is defined as multiple computer monitors, video projectors, or television sets tiled together contiguously or overlapped to form a large screen. Depending on the embodiment, the alarm computer 70 may further connect to an alarm device (e.g., a buzzer or a warning light) for notifying the user. The alarm computer 70 may be a data processing device or a computing device such as a personal computer, an application server, or a workstation, for example.

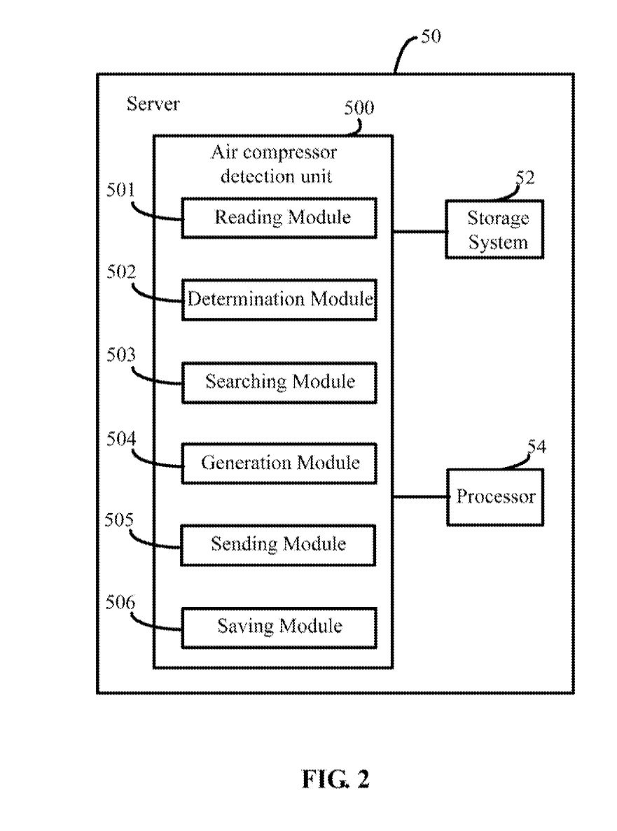

FIG. 2 is a block diagram of one embodiment of the server 50 including an air compressor detection unit 500. The air compressor detection unit 500 automatically collects the air compressor data and processes the air compressor data. In one embodiment, the air compressor detection unit 500 includes a reading module 501, a determination module 502, a searching module 503, a generation module 504, a sending module 505, and a saving module 506. The modules 501-506 may include computerized code in the form of one or more programs that are stored in the storage system 52. The computerized code includes instructions that are executed by the at least one processor 54 to provide functions for modules 501-506. The storage system 52 may be a memory, a hard disk drive, or a cache.

The reading module 501 reads the pipeline system data and the air compressor data from data converters 40. In one embodiment, the pipeline system data includes air temperatures, flow rates and air pressures. The air compressor data includes the work statuses of the air compressor 20, power-on duration of the air compressor 20, and power-off duration of the air compressor 20. In addition, the air compressor data is collected at a predetermined interval. For example, the predetermined interval may be every 2 minutes.

The determination module 502 analyzes the pipeline system data to determine if the air pressure of the pipeline system 100 is equal to the predetermined air pressure. In one embodiment, the predetermined air pressure may be 25 MPa.

The searching module 503 locates the air compressor 20 that needs to change the work status according to the air compressor data in response to a determination that the air pressure of the pipeline system 100 is not equal to the predetermined air pressure. In one embodiment, if the air pressure of the pipeline system 100 is less than the predetermined air pressure, the searching module 503 locates the air compressor 20 having the longest power-off duration, then the located air compressor 20 needs to be changed from the power-off work status to the power-on work status. In some embodiments, if the air pressure of the pipeline system 100 is greater than the predetermined air pressure, the searching module 503 locates the air compressor 20 having the longest power-on duration, then the located air compressor 20 needs to be changed from the power-on work status to the power-off work status.

The generation module 504 generates a warning message in response to a determination that the work status of the located air compressor 20 needs to be changed. In some embodiments, the warning message includes a serial number of the air compressor 20, information on how to change the work status of the located air compressor 20, and the reason to change the work status of the located air compressor 20.

The sending module 505 sends the warning message to the alarm computer 70 to notify a user in response to a determination that the work status of the located air compressor 20 needs to be changed. In one embodiment, the alarm computer 70 receives the warning message and sends the warning message to the user. For example, the alarm computer 70 sends an e-mail or a short message service (SMS) message to notify the user that the work status of the air compressor 20 needs to be changed. In addition, the alarm computer 70 may display the warning message on the display device 80 after the alarm computer 70 receives the warning message.

The saving module 505 saves the pipeline system data and the air compressor data into the database system 60. In one embodiment, the saving module 505 saves the air temperatures, flow rates and air pressures, the work statuses of the air compressor 20, power-on duration of the air compressor 20, and power-off duration of the air compressor 20 into the database system 60.

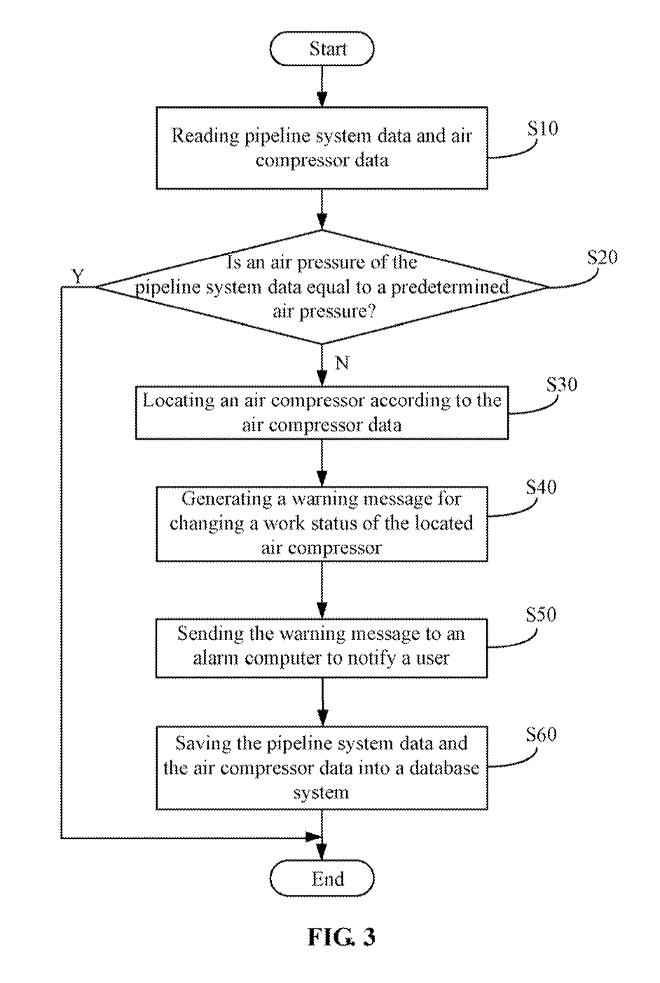

FIG. 3 is a flowchart of one embodiment of a method for detecting the air compressor 20. The method may be used to detect if the work status of the air compressor 20 needs to be changed. Depending on the embodiment, additional blocks may be added, others deleted, and the ordering of the blocks may be changed.

In block S10, the reading module 501 reads the pipeline system data and the air compressor data from data converters 40. As mentioned above, the pipeline system data includes air temperatures, flow rates and air pressures. The air compressor data include the work statuses of the air compressor 20, power-on duration of the air compressor 20, and power-off duration of the air compressor 20.

In block S20, the determination module 502 determines if the air pressure of the pipeline system 100 is equal to the predetermined air pressure. In one embodiment, the predetermined air pressure may be 25 MPa. For example, if the air pressure of the pipeline system 100 is less or greater than 25 Mpa, the procedure goes to block S30. If the air pressure of the pipeline system 100 is equal to 25 Mpa, the procedure goes to end.

In block S20, the searching module 503 locates the air compressor 20 that needs to change the work status according to the air compressor data. In one embodiment, assuming that the air pressure of the pipeline system 100 is less than 25 MPa, the searching module 503 searches for A1 and A2, and compares the power-off duration of A1 with the power-off duration of A2, if the power-off duration of A1 is longer than the power-off duration of A2, then the work status of A1 needs to be changed from the power-off work status to the power-on work status. In some embodiments, assuming that the air pressure of the pipeline system 100 is greater than 25 MPa, the searching module 503 searches for A1 and A2, and compares the power-on duration of A1 with the power-on duration of A2, if the power-on duration of A1 is longer than the power-on duration of A2, then the work status of A1 needs to be changed from the power-on work status to the power-off work status.

In block S30, the generation module 504 generates a warning message upon the condition that the work status of the located air compressor 20 needs to be changed. The warning message includes a serial number of the air compressor 20, information on how to change the work status of the air compressor 20, and the reason to change the work status of the air compressor 20. For example, if the work status of the air compressor A1 needs to be changed from the power-on work status to the power-off work status, the generation module 504 generates a warning message as following: A1, turn off the electrical connection with A1, and the air pressure of the pipeline system 100 is greater than the predetermined air pressure.

In block S50, the sending module 505 sends the warning message to the alarm computer 70 to notify a user. In one embodiment, the alarm computer 70 sends the warning message so that the user may be aware of the work status of the air compressor 20 quickly and easily. The warning message may be an e-mail or a short message service (SMS) message. In addition, the alarm computer 70 may display the warning message shown in the display device 80 upon receiving the warning message.

In block S60, the saving module 506 saves the pipeline system data and the air compressor data into the database system 60. In one embodiment, the user may set a scheduled time for starting a program for saving the pipeline system data and the air compressor data into the database system 60. For example, the user may set the time for starting the program at 9:00 A.M. If the current time is 9:00 A.M., the program for saving the pipeline system data and the air compressor data is executed.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A server in electronic communication with a pipeline system, comprising:
a storage system;
at least one processor; and
one or more programs stored in the storage system and being executable by the at least one processor, the one or more programs comprising:
a reading module operable to read pipeline data measured by sensors electronically communicating with the pipeline system, and read air compressor data measured by air compressor controllers electronically communicating with the pipeline system, the air compressor data comprising work statuses of one or more air compressors of the pipeline system, the pipeline system data comprising an air pressure of the pipeline system;
a searching module operable to locate an air compressor of the pipeline system according to work status change of the air compressor, the work status change according to a determination that the air pressure of the pipeline system is not equal to a predetermined air pressure; and
a sending module operable to send a warning message to an alarm computer in response to a determined work status change of the located air compressor.

2. The server of claim 1, wherein the air compressor data comprise power-on duration of the one or more air compressors of the pipeline system, and power-off duration of the one or more air compressors of the pipeline system.

3. The server of claim 2, wherein the searching module locates the air compressor having the longest power-on duration to change the work status of the located air compressor from a power-on work status to a power-off work status in response to the determination that the air pressure of the pipeline system is greater than the predetermined air pressure.

4. The server of claim 2, wherein the searching module locates the air compressor having the longest power-off duration to change the work status of the located air compressor from a power-off work status to a power-on work status in response to the determination that the air pressure of the pipeline system is less than the predetermined air pressure.

5. The server of claim 1, wherein the one or more programs further comprises a generation module operable to generate the warning message in response to the determined work status change of the located air compressor.

6. The server of claim 1, wherein the one or more programs further comprises a saving module operable to save the pipeline system data and the air compressor data into a database system.

7. A computer-based method for detecting work status of air compressors of a pipeline system, the method comprising:
reading pipeline data measured by sensors electronically communicating with the pipeline system, and reading air compressor data measured by air compressor controllers electronically communicating with the pipeline system, the air compressor data comprising work statuses of one or more air compressors of the pipeline system, the pipeline system data comprising an air pressure of the pipeline system;
locating an air compressor of the pipeline system according to work status change of the air compressor, the work status change according to a determination that the air pressure of the pipeline system is not equal to a predetermined air pressure;
sending a warning message to an alarm computer in response to a determined work status change of the located air compressor.

8. The method of claim 7, wherein the air compressor data comprise power-on duration of the one or more air compressors of the pipeline system, and power-off duration of the one or more air compressors of the pipeline system.

9. The method of claim 8, further comprising:
locating the air compressor having the longest power-on duration to change the work status of the located air compressor from a power-on work status to a power-off work status in response to the determination that the air pressure of the pipeline system is greater than the predetermined air pressure.

10. The method of claim 8, further comprising:
locating the air compressor having the longest power-off duration to change the work status of the located air compressor from a power-off work status to a power-on work status in response to the determination that the air pressure of the pipeline system is less than the predetermined air pressure.

11. The method of claim 7, further comprising:
generating the warning message in response to the determined work status change of the located air compressor.

12. The method of claim 7, further comprising:
saving the pipeline system data and the air compressor data into a database system.

13. The method of claim 7, wherein the pipeline system data and the air compressor data is read at a predetermined interval.

14. A non-transitory computer-readable medium having stored thereon instructions that, when executed by a computing device, causing the computing device to perform a method for detecting an air compressor, the method comprising:
reading pipeline data measured by sensors electronically communicating with the pipeline system, and reading air compressor data measured by air compressor controllers electronically communicating with the pipeline system, the air compressor data comprising work statuses of one or more air compressors of the pipeline system, the pipeline system data comprising an air pressure of the pipeline system;
locating an air compressor of the pipeline system according to work status change of the air compressor, the work status change according to a determination that the air pressure of the pipeline system is not equal to a predetermined air pressure;
sending a warning message to an alarm computer in response to a determined work status change of the located air compressor.

15. The non-transitory computer-readable medium of claim 14, wherein the air compressor data comprise power-on duration of the one or more air compressors of the pipeline system, and power-off duration of the air compressor.

16. The non-transitory computer-readable medium of claim 15, the method further comprising:
locating the air compressor having the longest power-on duration to change the work status of the located air compressor from a power-on work status to a power-off work status in response to the determination that the air pressure of the pipeline system is greater than the predetermined air pressure.

17. The non-transitory computer-readable medium of claim 15, the method further comprising:
locating the air compressor having the longest power-off duration to change the work status of the located air compressor from a power-off work status to a power-on work status in response to the determination that the air pressure of the pipeline system is less than the predetermined air pressure.

18. The non-transitory computer-readable medium of claim 14, the method further comprising:
generating the warning message in response to the determined work status change of the located air compressor.

19. The non-transitory computer-readable medium of claim 14, the method further comprising:
saving the pipeline system data and the air compressor data into a database system.

20. The non-transitory computer-readable medium of claim 14, wherein the pipeline system data and the air compressor data is read at a predetermined interval.
